(19) United States
(12) Patent Application Publication
(10) Pub. No.: US 2004/0205322 A1
(43) Pub. Date: Oct. 14, 2004

(54) Low-power decode circuitry for a processor

(76) Inventor: Charles F. Shelor, Arlington, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/410,981

(22) Filed: Apr. 10, 2003

(51) Int. Cl. G06F 9/30

(52) U.S. Cl. 712/209; 712/227

(57) ABSTRACT

A processor having improved decode logic is provided. In accordance with one embodiment, the processor includes a first decoder capable of decoding a first plurality of instructions, a second decoder capable of decoding a second plurality of instructions, and special instruction logic for implementing at least one special instruction, the at least one special instruction being an instruction that the first decoder or second decoder is not designed to directly decode for execution by an execution unit in the processor. In another embodiment, a related method is provided for decoding a processor instruction.

### FIELD OF THE INVENTION

The present invention is generally related to processors, and more particularly to decoder circuitry for a processor having a low-power operation.

### BACKGROUND

Processors (e.g., microprocessors) are well known and used in a wide variety of products and applications, from desktop computers to portable electronic devices, such as cellular phones and PDAs (personal digital assistants). As is known, some processors are extremely powerful (e.g., processors in high-end computer workstations), while other processors have a simpler design, for lower-end, less expensive applications and products.

As is also known, there is a general dichotomy between performance and power. Generally speaking, high-performance processors having faster operation and/or more complex designs tend to consume more power than lower-performance counterparts. Higher power consumption generally leads to higher operating temperatures and shorter battery life (for devices that operate from battery power). The ever-increasing demand and use of portable electronic devices is driving a demand to produce processors that realize lower-power operation, while at the same time maintaining satisfactory performance levels.

One known way of reducing the power consumption of devices is to provide modes of low-power operation (sometimes referred to as “sleep states”) when the devices (or certain portions thereof) are not in use. However, there is also a desire to reduce the power consumption of devices during active operation. This is often accomplished by providing more efficient designs to the operational components of the devices.

There are a number of power-consuming components in various electronic devices, and the processor is one of them. Even within a processor, there are a variety of functional sections, and decode logic is one such area. As is known, the decoder logic of a processor decodes an encoded instruction into a number electrical signals for controlling and carrying out the function of the instruction within execution logic provided on in the processor. FIG. 1 is a block diagram illustrating conventional decode logic within a processor.

At a very high level, the fetch/execute portion 10 of a processor includes fetch logic 12 for fetching an encoded instruction and decoder logic 14 for decoding the instruction. As mentioned above, the decoder 14 operates to decode an encoded instruction into a plurality of signal lines 15, which are used to control and carry out the execution of the encoded instruction. In this regard, the outputs 15 from the decoder 14 are signal lines that are used as inputs and/or control signals for other circuit components within an execution unit (not shown) of the processor, and the execution unit carries out the functional operations specified by the encoded instructions. This basic operation is well known, and need not be described further herein.

In processors that accommodate more than one instruction set, or that accommodate instructions that are not contained within the instruction set that is accommodated by the decoder 14, logic 16 may be provided for performing a translation of an encoded instruction that would otherwise be unrecognized by the decoder 14. One way that such instructions have been handled in prior art systems is to provide logic 16 that translates the otherwise unrecognized instruction into a sequence of instructions that are recognized by the decoder 14. Of course, when processing a sequence of instructions, additional clock cycles are required for the decoding and execution of those instructions. FIG. 1 illustrates one way of structuring the circuitry for implementing such an approach.

As illustrated in FIG. 1, a multiplexor 18 may be used to selectively input to a decoder 14 either an instruction retrieved directly from the fetch logic 12, or one or more translated instructions received from the translation logic 16. Control logic 20 may be provided for selecting the multiplexor 18 input that is to be directed to the decoder 14. Generally, the control logic 20 would evaluate the encoded instruction received from the fetch logic 12 to ascertain whether it is an instruction that is recognizable by the decoder 14. If so, the multiplexor 18 would be controlled so as to direct the output from the fetch logic 12 to the decoder 14. If, however, the control logic 20 determines that the encoded instruction retrieved from the fetch logic 12 is not an instruction that is recognizable by the decoder 14, then the control logic 20 would control the multiplexor 18 to direct the output of the translation logic 16 to the decoder 14. Of course, additional implementation details would be needed, but are not described herein, as persons of ordinary skill in the art understand the relevant implementation details of the circuitry illustrated in FIG. 1.

Circuitry such as that illustrated in FIG. 1, however, has certain drawbacks. Specifically, the complexity and power requirements of the circuitry are excessive. It will be appreciated that a tradeoff exists between the complexity of the decoder 14 and the complexity of the translation logic 16. In this regard, as more instructions are accommodated by the circuitry of the decoder 14, then the decoder 14 becomes larger and more complex, and therefore more power-consuming. This is particularly disadvantageous when a number of the instructions are used only seldomly. Conversely, as the design of the decoder 14 becomes more simplified to accommodate fewer, more basic instructions, then additional logic will be provided in the translation logic 16 to accommodate additional instructions. Furthermore, while the translation logic 16 is active (actively translating otherwise unrecognized instructions), the decoder 14 is also powered and active to decode the instructions output from the translation logic 16. The simultaneous operation of both decoder 14 and translation logic 16 results in increased power usage.

Accordingly, what is desired is an improved decoder logic design for a processor realizing more efficient and lower-power operation.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the advantages and novel features, the present invention is generally directed to a processor having improved decode logic. In accordance with one embodiment, the processor includes a first decoder capable of decoding a first plurality of instructions, a second decoder capable of decoding a second plurality of instructions, and special instruction logic for implementing at least one special instruction, the at least one special instruction being an instruction that the first decoder or second decoder is not designed to directly decode for execution by an execution unit in the processor.

In another embodiment, a method is provided for decoding a processor instruction. In one embodiment, the method determines whether the instruction is capable of being directly decoded within the decoder logic of the processor. If so, then the instruction is decoded and executed within the processor. If, however, the instruction is determined not to be directly decodable, then a determination is made as to a starting address for a memory area that contains software for carrying out the functionality of the instruction, and the routine is executed through a system call or other appropriate implementation.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a block diagram illustrating decode logic for a processor, as known in the prior art;

FIG. 2 is a block diagram illustrating a portable electronic device having a processor with decode logic, constructed in accordance with one embodiment of the invention;

FIG. 3 is a block diagram similar to FIG. 2, but illustrating an alternative embodiment of the invention;

FIG. 4 is a schematic diagram illustrating certain implementation features of one embodiment of the decode logic of the invention;

FIG. 5 is a schematic diagram illustrating an alternative implementation of an embodiment of the decode logic of the invention;

FIG. 6 is a flowchart illustrating certain steps of a method for performing a decode operation in accordance with an embodiment of the invention;

FIG. 7 is a flowchart illustrating certain steps in a method of performing a decode operation in accordance with an alternative embodiment of the invention;

FIG. 8 is a flowchart illustrating certain steps in a method of performing a decode operation in accordance with an alternative embodiment of the present invention;

FIG. 9 is a block diagram illustrating one embodiment for implementing the method of FIG. 8;

FIG. 10 is a block diagram illustrating the addressing made by secondary decoder logic to other logic for implementing a system call to a specified address;

FIG. 11 is a flowchart illustrating certain steps in a method of performing a decoder operation in accordance an embodiment of the present invention;

FIG. 12 is a block diagram illustrating one embodiment for implementing the method of FIG. 11;

FIG. 13 is a flowchart illustrating certain steps and a method of performing a decode operation in accordance with an alternative embodiment of the present invention;

FIG. 14 is a block diagram illustrating one embodiment for implementing the method of FIG. 13; and

FIG. 15 is a block diagram illustrating another embodiment for implementing the method of FIG. 13.

### DETAILED DESCRIPTION

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

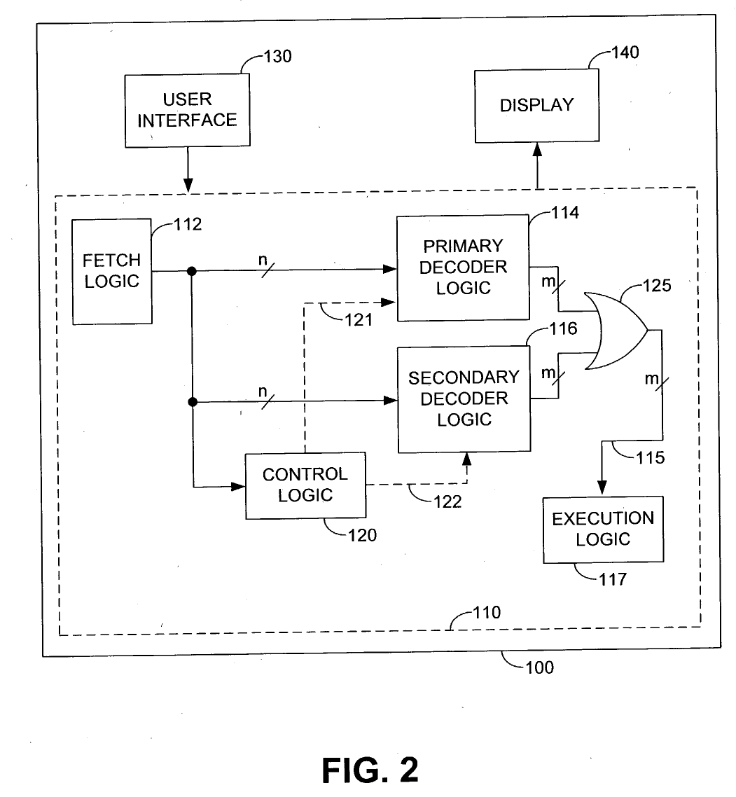

As described herein, there are various aspects of the inventive decode logic and method for decoding processor instructions. In accordance with one aspect of the invention, the decode logic includes multiple decoders, wherein each of the multiple decoders is uniquely designed to directly decode (i.e., decode in hardware) all instructions of an instruction set. FIGS. 2-7 illustrate embodiments of this aspect.

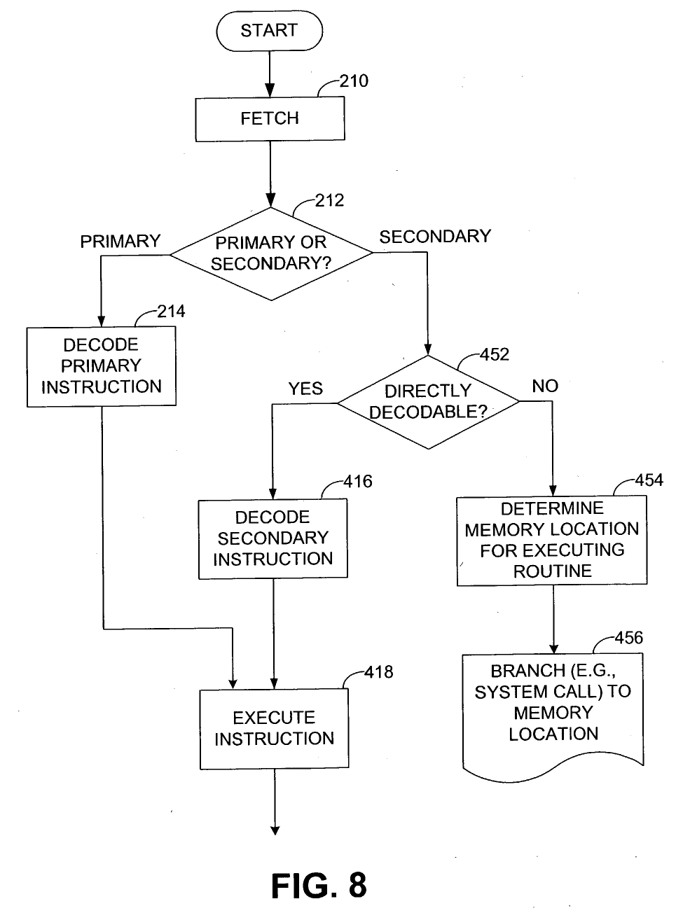

In accordance with another aspect of the invention, the decode logic includes multiple decoders, wherein one or more of the decoders may be designed to directly decode most, but not all instructions of an instruction set. For the instructions that are not directly decoded, the decode logic for that instruction set is designed to implement the instructions through calls to software. In one embodiment, the decode logic is configured to make system calls to memory locations having software for executing the otherwise undecoded (or undefined) instructions. In accordance with yet another aspect of the invention, the decode logic includes a single decoder designed to decode most, but not all, instructions of an instruction set. For the instructions that are not directly decoded, the decode logic for those instruction set is designed to implement the instructions through calls to routines defined in software. FIGS. 8-14 illustrate embodiments of these aspects.

Reference is now made to FIG. 2, which illustrates a portable electronic device 100 containing a processor 110 constructed in accordance with an embodiment of the present invention. As is known, there are an ever-increasing number of consumer and other portable electronic devices being developed and used. Most of these devices operate from battery power, and often include a user interface 130 (such as a keypad) and a display 140 (such as a flat-panel display). In many devices, the display 140 may include a touch-sensitive screen, which allows a user to input information through the display 140 as well. User interface 130, display 140, and other known aspects and features of the portable electronic device 100 need not be described herein, as they do not form a relevant part of the present invention.

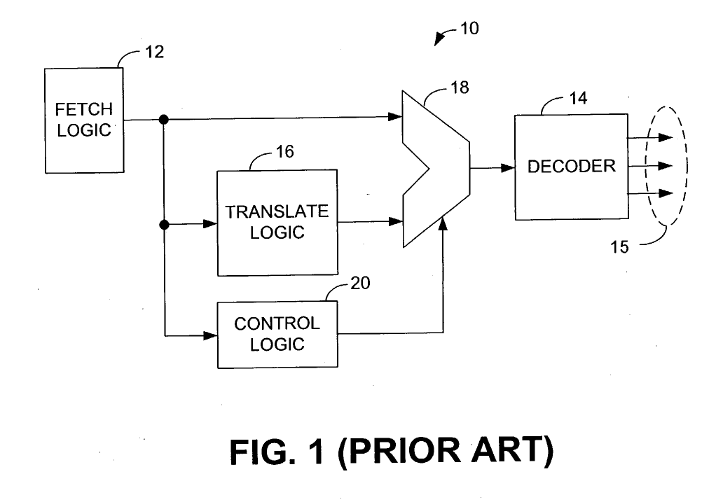

Instead, the present invention 110 is directed to circuitry and logic contained within the processor 110. Specifically, the present invention is directed to novel decoder logic for a processor that accommodates multiple instruction sets. Like the prior art processor of FIG. 1, a processor 110 constructed in accordance with one aspect of the invention may include conventional fetch logic 112 for fetching encoded instructions, and execution logic 117 for carrying out the functions and operations specified by the encoded instructions. Since these operations are known, they need not be described further herein.

In one embodiment, illustrated in FIG. 2, the processor 110 provides decoder logic for accommodating two distinct instruction sets. As an example, the processor 110 may be designed to accommodate both a 32-bit instruction set as well as a 16-bit instruction set. Multiple instruction sets, such as these may be provided for flexibility in programming, accommodation of legacy software, or other reasons. Generally speaking, 32-bit instruction sets may provide more powerful or robust code and programming capabilities, while 16-bit instruction sets provide for more compact code, which requires less memory. As will be appreciated by persons skilled in the art, other advantages or tradeoffs between 32-bit instruction sets and 16-bit instruction sets may be applicable as well.

Primary decoder logic 114 and secondary decoder logic 116 are provided for decoding instructions of a first (or primary) instruction set and a second (or secondary) instruction set, respectively. The output of the fetch logic 112 is directed to both the primary decoder logic and secondary decoder logic. Significant to this illustrated embodiment, control logic 120 is provided to selectively control the operation of the primary decoder logic 114 and secondary decoder logic 116 by control signals 121 and 122, such that when one of these logic blocks is operating to decode an instruction, the other of the logic blocks is inactive, and therefore consuming only a negligible amount of power. Further, and in contrast to the prior art diagram of FIG. 1, using multiple decoders in this way avoids the translation of instructions from one instruction set to the other before performing the decoding operation. Consequently, for instructions that, for example, fall into the secondary decoder logic instruction set, the elimination of the translation requirement into instructions of a format that may be decoded by the primary decoder 114, the operational speed of the processor is enhanced by avoiding wasted clock cycles in the translation and execution process.

As also illustrated in FIG. 2, the signal path between the fetch logic 112 and the decoders 114 and 116 is “n” bits wide (where “n” is an arbitrary integer, but usually a power of 2). This same signal path is input to the control logic 120, which evaluates the value on the data path output from the fetch logic to determine whether the primary decoder logic 114 or secondary decoder logic 116 should be activated to decode the encoded instruction.

In contrast, “m” signal lines are output from each decoder 114 and 116. Generally speaking, “m” is an integer, which generally will not be the same number as “n.” Instead, “m” is an integer that represents the number of signal and control lines that are required by the execution unit 117 for executing the encoded instructions. Of course, the number of signal lines “m” will be implementation specific, based upon the specific circuitry of the execution logic 117. In the illustrated embodiment, there is a 1-to-1 correspondence between the signals output from the primary decoder 114 and the signals output from the secondary decoder 116, and they may be combined by, for example, a logical OR operation 125. In this regard, in the illustrated embodiment, the outputs of the inactive decoder 114 or 116 will be a logic zero. Therefore, the OR operation 125 simply passes the logical values of the signal lines of the active decoder logic 114 or 116 to the execution unit 117 on signal bus 115.

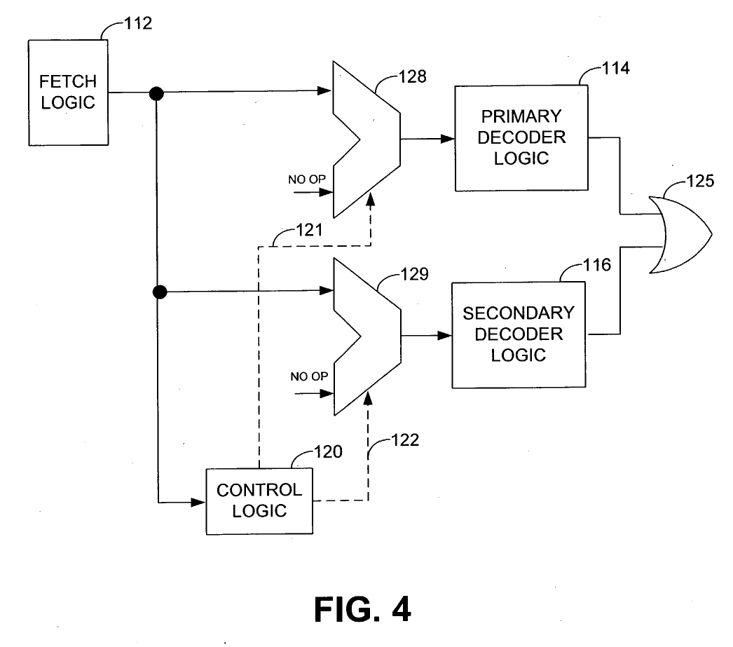

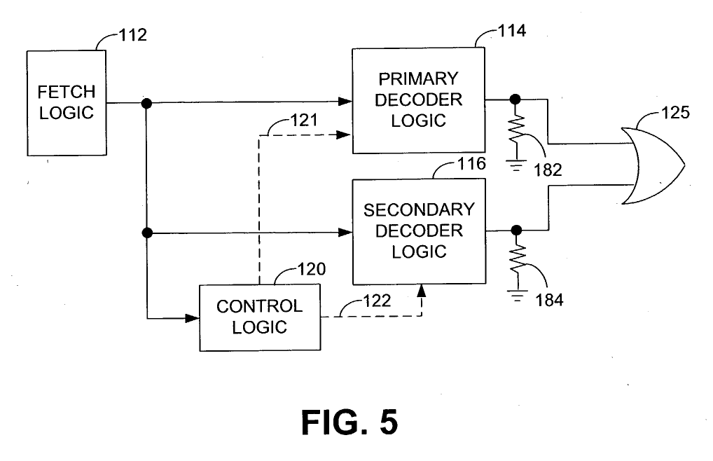

It will be appreciated by persons skilled in the art that there are a variety of ways to specifically implement the concepts illustrated in the diagram of FIG. 2, and the broader aspects of the present invention are not limited by any particular implementation. One example implementation will be described briefly in reference to FIG. 4, while an alternative implementation will be described briefly in reference to FIG. 5 (below). However, it should be appreciated that other implementations may be provided as well.

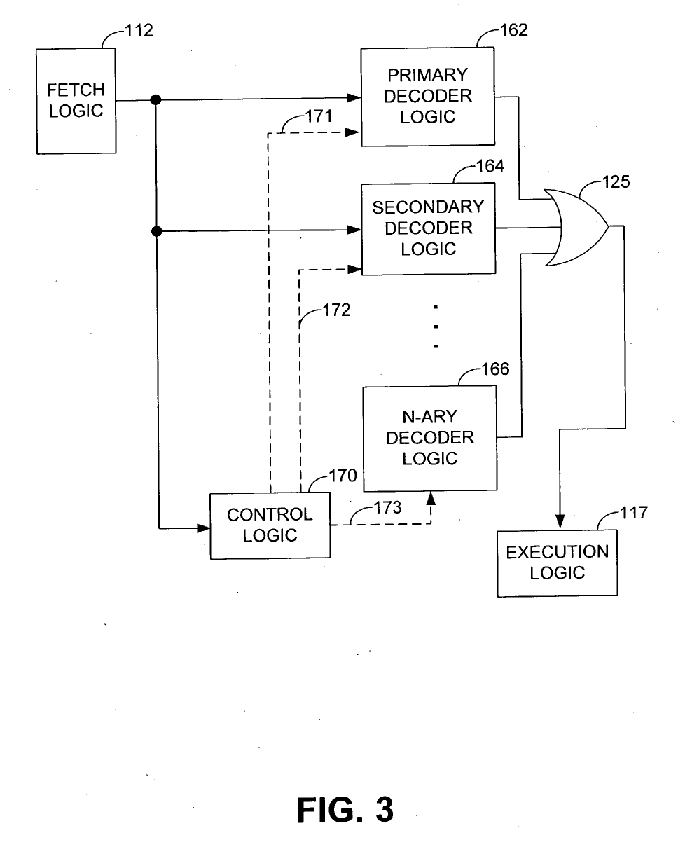

Reference is now made to FIG. 3, which is a block diagram illustrating an alternative embodiment of the decoder logic. The fetch logic 112, execution logic 117, and logical OR operation 125 have been assigned the same reference numerals as the corresponding circuit elements and logic blocks of FIG. 2, to represent similar functionality and implementation. Therefore, these blocks need not be redescribed in connection with FIG. 3. The principle difference between the embodiment of FIG. 2 and the embodiment of FIG. 3 is the inclusion of additional decoder logic elements for accommodating additional instruction sets. In this regard, decoder elements 162, 164, and 166 are illustrated, and these decoder elements are labeled as “primary decoder logic,” “secondary decoder logic,” and “n-ary decoder logic.” The function and operation of each of these decoder logic elements is similar to that described in connection with FIG. 2. In the embodiment of FIG. 3, additional instruction sets are accommodated. In one embodiment, the decoder logic of the processor accommodates three distinct instruction sets. Like the embodiment of FIG. 2, one instruction set is a 32-bit instruction set, one instruction set is a 16-bit instruction set, and third instruction set is for JAVA instructions. Such an embodiment or instruction set is useful in devices that provide a Web interface, as JAVA is the programming language utilized by many Web-based applications.

Further, control logic 170 is provided and operates to generate control signals 171, 172, and 173 for controlling the selective operation of the decoder elements 162, 164, and 166, respectively. Again, and as described in connection with FIG. 2, the control logic 170 operates to evaluate an encoded instruction received from the fetch logic 112 and make the determination as to whether to activate the primary decoder logic 162, secondary decoder logic 164, or the n-ary decoder logic 166 for decoding the instruction. The control logic 170 controls the state of the control signals 171, 172, and 173 to ensure that all remaining decoder elements (not actively decoding an instruction) are maintained in an inactive, low-power state.

Reference is now made to FIG. 4, which illustrates an embodiment for implementing the controlled and selective operation of decoder logic elements 114 and 116 (of FIG. 2). Of course, a similar implementation may be provided for implementing the selective and controlled operation of the decoder elements 162, 164, and 166 of FIG. 3 as well. In the illustrated embodiment of FIG. 4, multiplexors 128 and 129 are provided, and the control logic 120 outputs the control signals 121 and 122 for controlling the select logic that is provided within the multiplexors 128 and 129. Each multiplexor 128 and 129 is configured to direct the encoded instruction received from fetch logic 112 to its corresponding decoder logic 114 and 116. Each multiplexor 128 and 129 is further illustrated as having a “no op” input. In one embodiment, the no op input is a value that is otherwise unrecognized by the particular decoder logic. Such a predetermined value causes the decoder logic to enter an inactive (low-power) state of operation. In one implementation, this may be realized through the implementation of decoder logic using CMOS technology, whereby an inactive state of operation results in only a quiescent power draw of its internal gates. As is known, such a low-level power draw is virtually negligible with respect to power demands from the battery or other power source that powers the device.

In operation, the control logic 120 operates to ensure that the output of the fetch logic 112 will not be passed through both multiplexors 128 and 129 at the same time. That is, the select lines 121 and 122 are controlled such that at least one no op instruction is passed through a multiplexor to the corresponding decoder logic at any given time. Further, there may be other times (e.g., idle states), in which the control logic 120 controls both multiplexors 128 and 129 to pass the no op instructions through to the respective decoder logic 114 and 116, respectively, so that both decoders are simultaneously operated in the inactive low-power state, thereby realizing greater power savings.

Reference is now made to FIG. 5, which is a block diagram showing an alternative implementation of a portion of the decoder logic of an embodiment of the present invention. As mentioned in connection with FIG. 4, one implementation for achieving the low-power operation of the decoder logic may be realized through the utilization of CMOS logic and its low-power, quiescent operation at certain times. Another embodiment, utilizing a differing (non CMOS) logic may be implemented, wherein enable signals 121 and 122 may be provided to the decoder logic 114 and 116, respectively, to selectively disable the decoder operation and place them in low-power modes of operation. If such an implementation causes the outputs of the decoder logic elements 114 and 116 to float (or go to a tri state), and therefore be in an unstable or uncertain state, then pull down resistors 182 and 184 may be placed on the signal path of each signal output from the respective decoders 114 and 116. These resistors 182 and 184 would, of course, be high impedance resistors to limit the current draw therethrough, and therefore the current draw on the power source.

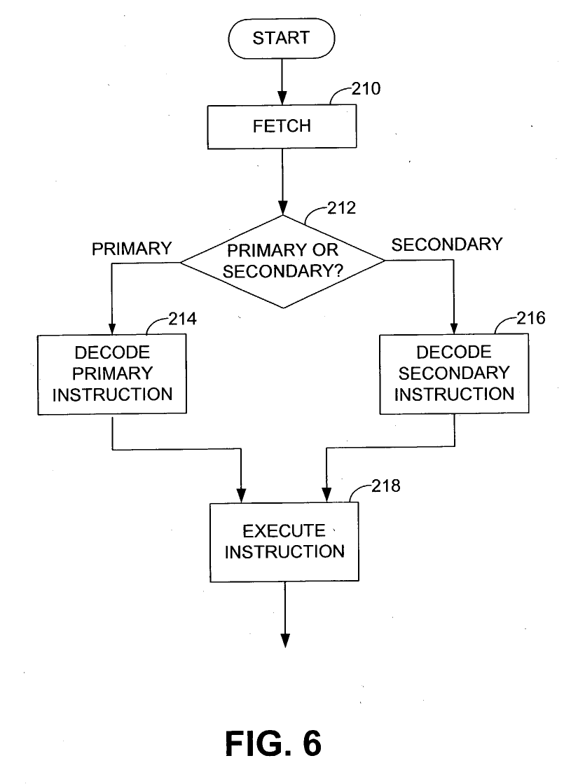

Having described certain features and architectural implementations of certain aspects of embodiments of the present invention, reference is now made to FIG. 6, which is a flowchart illustrating the top-level operation of an embodiment of a method implemented in accordance with an embodiment of the invention. In accordance with the illustrated embodiment, a fetch 210 is performed to retrieve an encoded instruction from a memory location. Thereafter, the method evaluates the encoded instruction (step 212) to determine whether the instruction is an instruction supported by first or primary instruction set or whether the instruction is within a second or secondary instruction set. If step 212 determines that the encoded instruction is an instruction of a primary instruction set, then the method directs the encoded instruction to a decoder for decoding primary instruction (step 214). If step 212 determines that the instruction belongs to a secondary instruction set, then the encoded instruction is directed to circuitry for decoding the secondary instruction (step 216). Thereafter, the decoded instruction is executed at step 218.

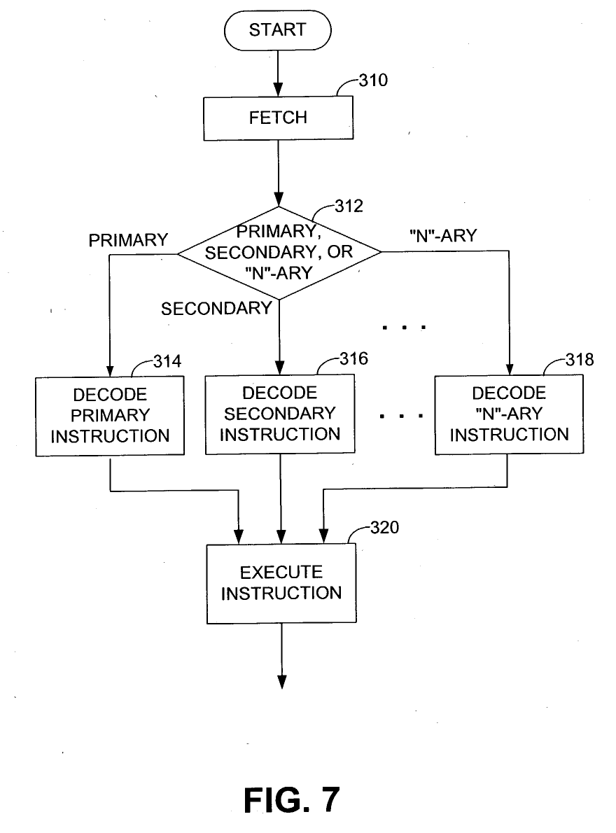

Reference is now made to FIG. 7, which is a flowchart illustrating the top-level operation of an alternative embodiment of the present invention. In accordance with the method of FIG. 7, a fetch operation is performed at step 310. Then, at step 312, the method determines whether the fetched instruction belongs to a primary, secondary or other instruction set. Based upon the resolution of step 312, the encoded instruction is directed to a decoder for decoding instructions within a primary instruction set (step 314), decoding instructions within a secondary instruction set (step 316), or decoding instructions within some other instruction set (step 318). Thereafter, the decoded instruction is executed at step 320.

The foregoing description has described certain features of embodiments of the present invention, wherein dedicated decoders are provided to directly decode all instructions of multiple instruction sets. However, in situations where the decode circuitry may become undesirably complex (for cost or other reasons), then the decode logic for one or more instruction sets may be designed to directly decode fewer than all of the instructions. In such embodiments, the decode logic may be designed to accommodate special instructions (e.g., otherwise undecoded instructions) by redirecting the processor (through system calls or otherwise) to memory locations having software routines for executing the special instructions.

The foregoing description of FIGS. 2-7 has set forth certain features and embodiments of an aspect of the decode logic of the present invention, wherein multiple dedicated decoders are provided for decoding instructions of differing instructions sets, and wherein the decode logic is configured to operate the multiple decoders such that only one decoder is operative at any given time. Reference is now made to FIGS. 8-14, which illustrate embodiments of another aspect of the present invention, which relates to the decoding of an otherwise undefined (i.e., special) instruction. As used herein, a special instruction is one that is not directly decodable by the hardware or circuitry of the decoder logic. Referring first to FIG. 8, a flowchart is provided which is a similar, but modified, version of the flowchart illustrated in FIG. 6. As discussed in connection with FIG. 6, an early step in the instruction-processing pipeline of a processor is the fetch (step 210). Thereafter, decode logic determines whether the fetched instruction is an instruction belonging to a primary or secondary instruction set (step 212). If it is determined that the instruction belongs to a secondary instruction set, then the decode logic (e.g., secondary decoder logic) determines whether the instruction is one that is directly decodable (step 452). In this regard, there are instances in which the decoder logic may be unduly complicated by the accommodation of all instructions in a particular instruction set. The cost or complexity added to decoder logic to accommodate all instructions may not justify slight performance gain realized by direct decoding, particularly for instructions that are very infrequently used. The decoder logic may not be designed to directly decode such seldom-used instructions, but instead implement their functionality through software, exception handling, or otherwise.

In keeping with the description of FIG. 8, if it is determined that the instruction is directly decodable, then the secondary decoder decodes the instruction (step 416) in the same fashion described in connection with FIG. 6. Thereafter, the decoded instruction is passed to an execution unit of the processor, which executes the instruction (step 418). If, however, it is determined that the instruction is not directly decodable, then the decoder logic of one embodiment determines a memory location that defines a start address for a software routine that controls or carries out the functionality of the otherwise undefined instruction (step 454). Preferably, such a routine is written using instructions that are directly decodable by either the primary or secondary instruction decoder of the processor. After determining the memory location for the executing routine, the method redirects the processor to that location for executing the functionality of the instruction (step 456). In one embodiment, this may be performed by a system call to the specified memory location. In one embodiment, the end of the memory area defining the software routine for executing the special instruction may end with a “return” instruction, which instructs the program counter of the processor to resume execution at the point in the program immediately following the special instruction.

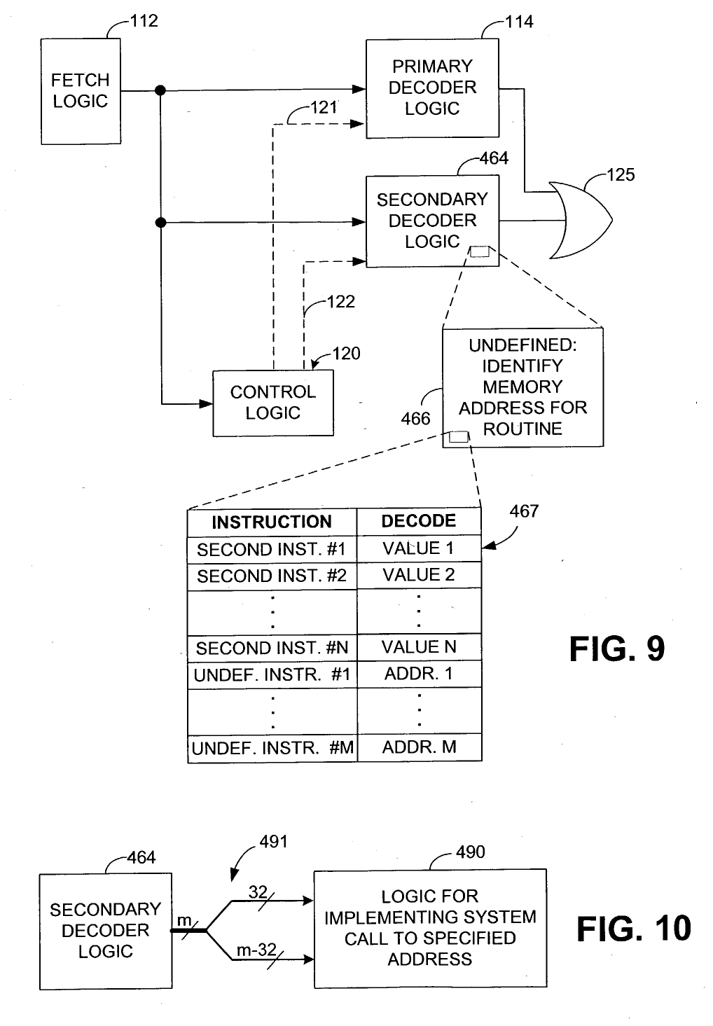

Reference is now made to FIG. 9, which is a block diagram illustrating certain features of an embodiment of a decoder for implementing the special-instruction handling method of FIG. 8. The block diagram of FIG. 9 is similar to the block diagram of the processor 110 of FIG. 2, and therefore like components have been identified with like reference numerals, and need not be re-described herein. In this regard, the principle difference between the implementation of the processor 110 of FIG. 2 and that of FIG. 9 relates to internal logic within in the secondary decoder logic 464 that is configured to handle instructions of a secondary instruction set that are otherwise undefined, or not directly decodable, by the secondary decoder logic 464. Specifically, the secondary decoder logic 464 includes a component 466 that is configured to identify a starting address of a memory area that contains code defining software for carrying out the functional operation of the instruction that is otherwise undefined, or not directly decodable, by the secondary decoder logic 464. In one implementation, such a component 466 may include a look-up table 467 that provides output values for the secondary decoder logic 464 for each special instruction encountered. Indeed, in one embodiment, the look-up table 467 may provide output decoder values for all instructions (both defined and undefined) for the secondary decoder logic 464.

As previously mentioned, the decoder logic includes a number of output signals that carry both data and control signals for carrying out the execution of the decoded instruction within the processor. As illustrated in FIG. 10 with reference to the secondary decoder logic 464, the outputs 491 of the secondary decoder logic 464 may be divided into two portions. A first portion may contain thirty-two bits that define immediate data that is output from the secondary decoder logic 464, while the remaining bits or signals are carried on the remaining output signal lines. These output signals may be directed to an execution unit within the processor. This execution unit or execution logic may include logic 490 for implementing a system call to a specified address. Thus, in the context of executing special instructions, the secondary decoder logic 464 may be configured to output a 32-bit field specifying an immediate address that the processor is to branch to perform a system call or instruction handling routine for the special instruction. The remaining signals output from the secondary decoder logic may specify that the data carried on the 32-bit immediate data field is specifying an address for such special instruction handling. Thus, rather than controlling the actual execution of the instruction within an instruction-execution unit of the processor, the outputs of the decoder may simply control the operation of components within the processor to perform a system call to the relevant address for handling a special instruction.

Returning to FIG. 9, the look-up table 467 illustrates N identifiable instructions within the second instruction set, and associated decoder values of 1 to N. These decoder values are numerical representations of the bit status or outputs of the secondary decoder logic. Similarly, the look-up table 467 illustrates M undefined instructions that may be accommodated or handled by separately-defined software routines stored in a memory area. Each such routine may be specified within the look-up table 467 by the starting address (ADDR. 1-ADDR. M, respectively) of the routine for handling the special instruction. Of course, consistent with the scope and spirit of the present invention, additional mechanisms and logic may be provided for implementing the handling of special instructions.

Further, consistent with the scope and spirit of the present invention, the primary decoder logic 114 may be modified to include a component similar to 466 for implementing special-instruction handling routines of instructions of primary instructions that are not directly decodable by the primary decoder logic 114. Further, this aspect of the present invention may be applied to additional decoders, if the processor includes more than two decoders for the accommodation of more than two instruction sets. In one embodiment of the present invention, as mentioned above, three decoders are implemented. One decoder is for decoding instructions of a 32-bit instruction set; one decoder is for decoding instructions of a 16-bit instruction set; and one decoder is provided for decoding JAVA instructions. One implementation of the present invention provides for the accommodation of 256 JAVA instructions. Of those 256 JAVA instructions, approximately 246 are directly decodable, while remaining approximately ten are implemented through system calls to specifically-defined software routines for carrying out those remaining instructions.

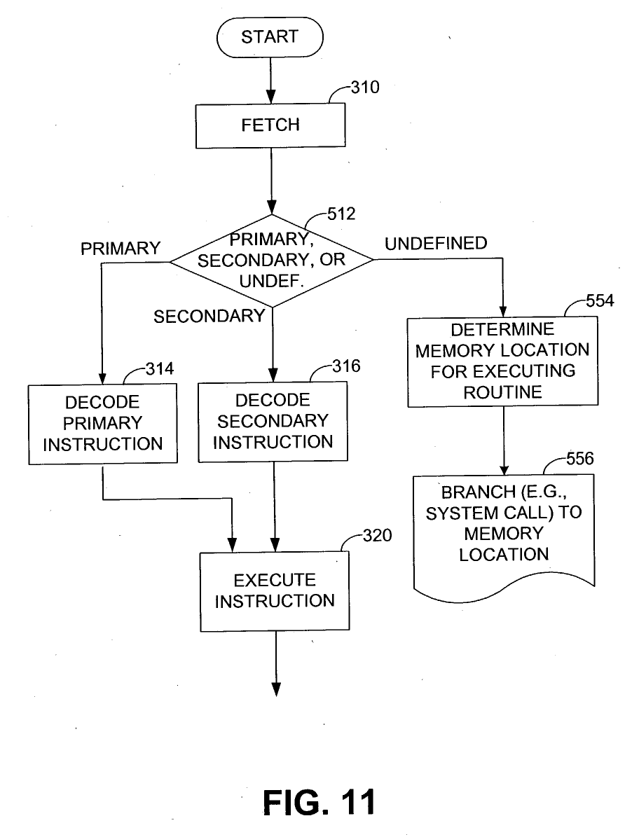

Reference is now made to FIG. 11, which is a flowchart illustrating an alternative embodiment of the present invention. The flowchart of FIG. 11 illustrates a slightly different approach to handling special instructions that may be encountered. In this regard, the flowchart is similar to the flowchart of FIG. 7. In FIG. 7, step 312 identified whether the fetched instruction was of a primary, secondary, or other instruction set. In contrast, the corresponding step 512 of FIG. 11 determines whether the fetched instruction is of a primary instruction set, secondary instruction set, or undefined instruction. In this regard, the undefined instruction may be an undefined instruction of either the first instruction set or the second instruction set. That is, the embodiment of FIG. 11 may handle undefined instructions of multiple instruction sets collectively. As illustrated in FIG. 11, if it is determined that the fetched instruction is a special instruction (i.e., undefined by either the primary instruction set or the secondary instruction set), then the method determines a starting address for a memory location for executing the instruction (step 554). Thereafter, the method may implement a system call (step 556) to that memory location. Thereafter, instructions defined in the memory area for handling the identified special instruction are fetched and executed by the processor until a “return” instruction (or other appropriate ending instruction) is received and processed, after which execution is resumed at the instruction immediately following the special instruction that was identified.

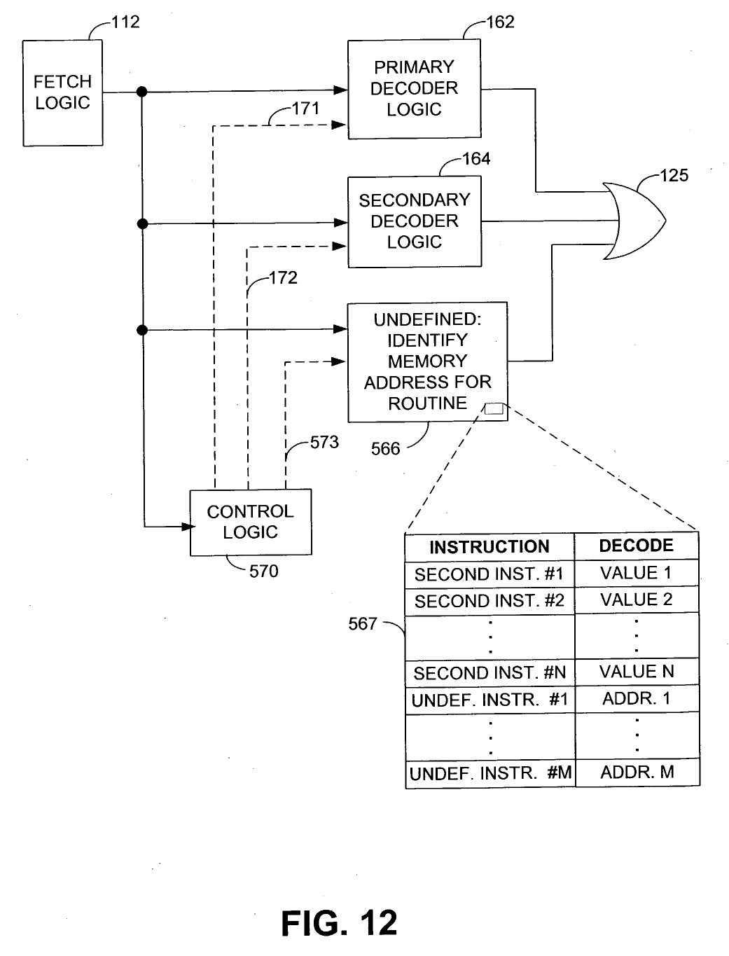

Reference is now made briefly to FIG. 12, which is a block diagram similar to the block diagram of FIG. 9, and illustrating one potential embodiment for implementing the functional aspects of the embodiment illustrated in FIG. 11. The description of the components illustrated in FIG. 12 has been provided above in connection with at least FIGS. 3 and 9, and need not be repeated herein. What is significant for purposes of the embodiment of FIG. 12 is that the logic 566, for identifying a starting address of a memory area that contains software instructions for executing the otherwise undefined instruction, is provided separate and apart from the primary decoder logic 162 and secondary decoder logic 164. In this regard, the special instruction handling need not be associated with a particular decoder, but may be separately implemented. A look-up table 567, similar to the look-up table 467 described in connection with FIG. 9, is one implementation for carrying out this feature.

FIG. 12 further illustrates a signal 573 from the control logic 570 that is directed to the component 566. Consistent with the aspect of the invention described in connection with FIGS. 2-7, the embodiment of FIGS. 11 and 12 may be implemented such that control logic 570 controls the selective operation of the primary decoder logic 162, secondary decoder logic 164, and logic for identifying a starting memory address for undefined instruction 566, such that only one of those three components is actively operating at any given time, thereby minimizing the power draw of the decode logic of the processor.

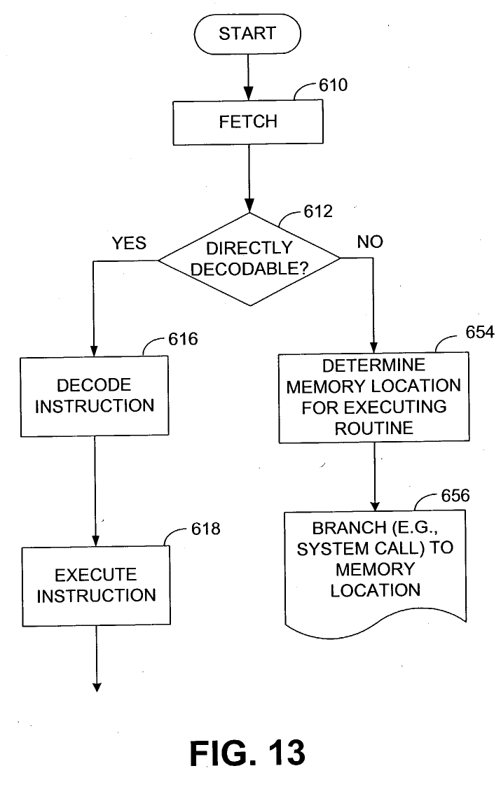

Reference is now made to FIG. 13, which is a flowchart illustrating certain steps of a method constructed in accordance with yet another embodiment of the present invention. In this regard, FIG. 13 illustrates an embodiment of the special-instruction handling within a processor designed to execute instructions of only a single instruction set. As in previous embodiments, an early step in the processing pipeline is the instruction fetch (step 610). Thereafter, the method may determine whether the fetched instruction is directly decodable by the decoder of the processor (step 612). If so, the decode circuitry of the processor operates to decode the instruction (step 616), and thereafter execute the instruction (step 618). If, however, it is determined that the instruction is not directly decodable by the decode logic of the processor, then the method may determine a memory location for a starting address of a software routine for carrying out the function or operation of the instruction (step 654). Thereafter, the method may instruct a processor to perform a system call to the starting address identified in step 654 (step 656).

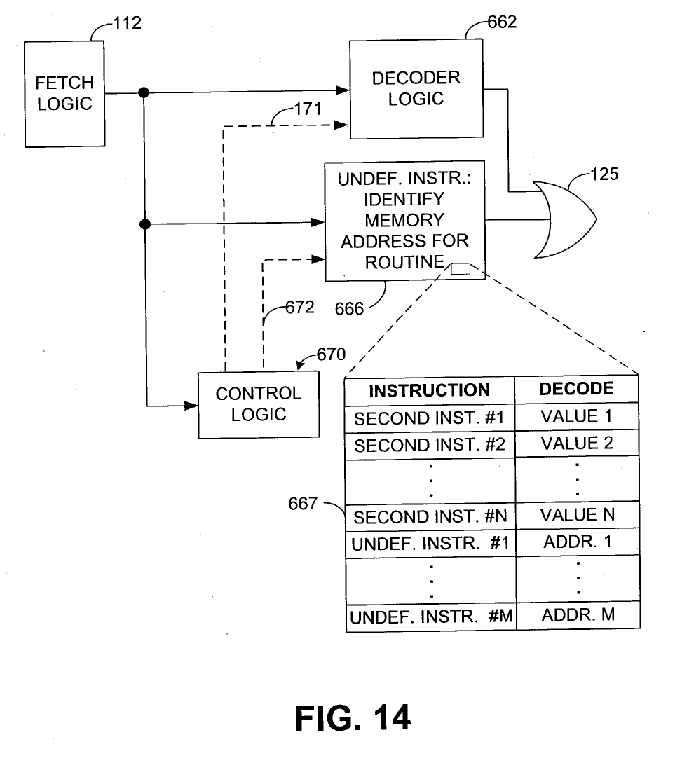

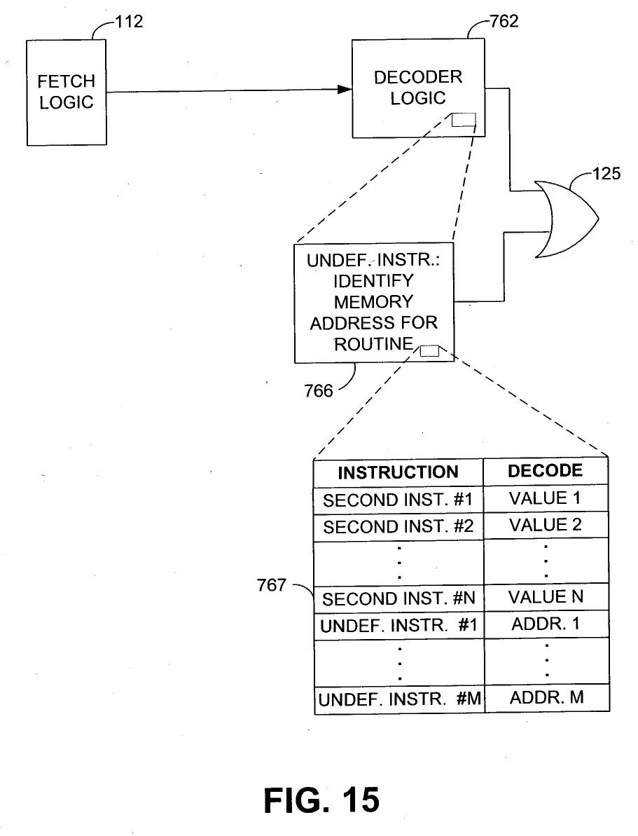

Reference is now made briefly to FIGS. 14 and 15, which illustrate alternative physical embodiments for implementing the method of FIG. 13. In the embodiment of FIG. 14, logic 666 for identifying the starting address for the software that carries out the special instruction(s) is provided separate and distinct from decoder logic 662. In one embodiment, control logic 670 may provide control signals 171 and 672 for controlling the respective operation of decoder logic 662 and the logic 666 for identifying the starting memory address for special instructions such that only one of these logic components is actively operative at any given time, thereby minimizing the power demands of this portion of the decode logic.

In an alternative configuration, as illustrated in FIG. 15, logic 766 for identifying the starting addresses for memory areas containing software for carrying out otherwise undefined instructions is integrated within decoder logic 762. A similar aspect was illustrated and described in connection with FIG. 9, and therefore need not be described again in connection with FIG. 15.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A processor comprising:
fetch logic for fetching an encoded instruction;
first decoder logic capable of decoding a plurality of encoded instructions of a first instruction set, the first decoder logic having an input to receive an encoded instruction output from the fetch logic;
second decoder logic capable of decoding a plurality of encoded instructions of a second instruction set, the second decoding logic having an input to receive an encoded instruction output from the fetch logic; and
special instruction logic associated with the second decoder logic for implementing at least one special instruction of the second instruction set, the at least one special instruction being an instruction that the second decoder logic is not designed to directly decode for execution by an execution unit in the processor.

2. The processor of claim 1, wherein the special instruction logic includes logic configured to identify an address of a memory area storing a routine for carrying out the special instruction.

3. The processor of claim 2, wherein the special instruction logic includes logic for directing a system call to the address of the memory area.

4. The processor of claim 2, further including special instruction logic associated with the first decoder logic for implementing at least one special instruction of the first instruction set, the at least one special instruction for the first instruction set being an instruction that the first decoder logic is not designed to directly decode for execution by the execution unit in the processor.

5. The processor of claim 1, further including decoder control logic configured to selectively control active operation of the first decoder logic and the second decoder logic, such that when the first decoder logic is decoding an instruction then the second decoder logic is operated in a lower-power, inactive mode, and when the second decoder logic is decoding an instruction then the first decoder logic is operated in a lower-power, inactive mode.

6. The processor of claim 1, wherein each of the instructions of the second instruction set are different from each of the instructions of the first instruction set.

7. The processor of claim 1, further including execution logic for executing instructions decoded by the first and second decoder logic.

8. A portable electronic device comprising the processor of claim 1.

9. The processor of claim 1, wherein the decoder control logic is responsive to the encoded instruction output from the fetch logic, the decoder control logic being configured further ensure that no more than one of the first decoder logic and second decoder logic are actively operative at a given time.

10. The processor of claim 1, further including third decoder logic capable of decoding a plurality of instructions of a third instruction set, the third decoder logic having an input to receive an encoded instruction output from the fetch logic.

11. The processor of claim 10, wherein the decoder control logic is further configured to selectively control active operation of the first decoder logic, the second decoder logic, and the third decoder logic, such that no more than one of the first decoder logic, second decoder logic, and third decoder logic are actively operative at a given time.

12. The processor of claim 11, wherein the decoder control logic is further configured to ensure that, when any one of the first decoder logic, second decoder logic, and third decoder logic components is actively operating to decode an instruction, that all other decoder logic components is maintained in an inactive, low-power state.

13. A processor comprising:
a plurality of decoders, each of the plurality of decoders being uniquely designed for decoding a plurality of instructions that are distinct and nonoverlapping with the instructions to be decoded by the remaining decoders; and
special instruction logic associated with the at least one of the decoders for implementing at least one special instruction, the at least one special instruction being an instruction that the decoders are not designed to directly decode for execution by an execution unit in the processor.

14. The processor of claim 13, further including decoder control logic configured to ensure that only one of the plurality of decoders is operative to decode an instruction at any given time and to ensure that the remaining decoders are maintained in inactive, low-power modes while the one decoder is actively decoding an instruction.

15. The processor of claim 13, further including execution logic for executing decoded instructions.

16. A portable electronic device comprising the processor of claim 13.

17. A processor comprising:
a first decoder capable of decoding a first plurality of instructions;
a second decoder capable of decoding a second plurality of instructions; and
special instruction logic for implementing at least one special instruction, the at least one special instruction being an instruction that the first decoder or second decoder is not designed to directly decode for execution by an execution unit in the processor.

18. The processor of claim 17, further including decoder control logic configured to selectively control active operation of the first decoder and the second decoder, such that, when the first decoder is decoding an instruction, then the second decoder is maintained in a lower-power, inactive mode.

19. The processor of claim 18, wherein the decoder control logic is further configured to selectively control active operation of the first decoder and the second decoder, such that when the second decoder is decoding an instruction then the first decoder is maintained in a lower-power, inactive mode.

20. A method for decoding a processor instruction comprising:
determining whether the instruction is an instruction of a first instruction set or a second instruction set;
if the instruction is determined to be an instruction of a first instruction set, then decoding the instruction using a first decoder;
if the instruction is determined to be an instruction of a second instruction set, then directly decoding the instruction using a second decoder, if the instruction is directly, decodable by the second decoder; and,
if the instruction is determined to be an instruction of the second instruction set, then causing the instruction to be executed through a call to software defined in a memory area, if the instruction is not directly decodable by the second decoder.

21. The method of claim 20, further comprising causing the first decoder to remain in an inactive, low-power mode while the second decoder is decoding the instruction, if the instruction is determined to be an instruction of the second instruction set.

22. The method of claim 20, further comprising causing the second decoder to remain in an inactive, low-power mode while the first decoder is decoding the instruction, if the instruction is determined to be an instruction of the first instruction set.

23. The method of claim 20, wherein the determining further comprises determining whether the instruction is an instruction of a first instruction set, a second instruction set, or a third instruction set.

24. A method for decoding a processor instruction comprising:
determining whether the instruction is directly decodable by a decoder within the processor;
if the instruction is determined to be directly decodable, then decoding the instruction using the decoder; and
if the instruction is determined not to be directly decodable, then causing the instruction to be executed through a call to software defined in a memory area.

25. A processor comprising:
fetch logic for fetching an encoded instruction;
decoder logic configured to decode a plurality of encoded instructions of an instruction set, the decoder logic having an input to receive an encoded instruction output from the fetch logic; and
special instruction logic associated with the decoder logic for implementing at least one special instruction of the instruction set, the at least one special instruction being an instruction that the decoder logic is not designed to directly decode for execution by an execution unit in the processor.

26. The processor of claim 25, wherein the special instruction logic includes logic configured to identify an address of a memory area storing a routine for carrying out the special instruction.

27. The processor of claim 26, wherein the special instruction logic further includes logic for directing a system call to the address of the memory area
